(19) United States
(12) Patent Application Publication
(10) Pub. No.: US 2007/0199516 A1
(43) Pub. Date: Aug. 30, 2007

(54) Game surrogate device

(76) Inventor: Greg Koch, (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/364,268

(22) Filed: Feb. 28, 2006

(51) Int. Cl. A01K 31/19

(52) U.S. Cl. 119/300; 119/302

(57) ABSTRACT

A game surrogate device for game chicks comprising a brooding chamber, free-range chamber, and a movable partition.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to a device and method for game bird chick survival, and more particularly to a device adapted to increase game bird survival after the chicks are released into the wild at about five weeks of age.

### DESCRIPTION OF RELATED ART

Various systems and devices used to develop a huntable population of game birds, such as quail, chukkars, Hungarian partridge, grouse, pheasants, and the like, are well known. Traditionally, the birds are pen-raised and then released in the wild. Unfortunately, quail that are pen-raised reportedly have as much as a 95% mortality rate in the week after released into the wild. Further, pen-raised birds are imprinted to the location where they are raised, which is usually hundreds of miles from the area of release. As a result, pen-raised birds feel no inner compulsion to remain in the release area and consider it home. Pen-raised birds thus also have high mortality rates when released into the wild.

To help decrease the mortality rate, feeding, and watering systems for adult wild upland game birds have been developed as generally described in Rayborn, U.S. Pat. No. 5,924,380. These devices are designed to permit the covey of about 20-30 pen-raised adult wild birds to become acclimated to the device over a period of 6-7 days. The adult birds are permitted to leave the feeding/watering enclosure during the day and then return for feeding/watering at specified times.

More recently, the present inventors developed a new approach to developing a huntable population of game birds using a device known as a surrogator device. The surrogator device is designed to provide necessary food, water, heat, and protection to the game chicks shortly after birth until about five (5) weeks of age. At that time, the chicks are released into the wild. The surrogator device protects the chicks during the time that they are most vulnerable. However, in contrast to adult-released birds, the chicks show an increased ability to retain their survival instincts and survive in the wild.

Conventional surrogator devices were comprised entirely of metal. These devices were relatively heavy. In addition, the metal attracted condensation, which increased the humidity in the air, causing many of the young chicks to perish prematurely. Thus, despite the advances associated with surrogate devices, there remains a need to develop an improved surrogator device.

### BRIEF SUMMARY OF THE INVENTION

The present invention is directed to a surrogate system for game chicks up to about five weeks of age. The surrogate system includes a brooding chamber, which shields the game chicks from the wind and rain. The brooding chamber has a food source, a water source, and a heat source for the game chicks. The surrogate system also has a free-range chamber that permits the chicks to be exposed to the wind and rain and helps them acclimate to their surroundings.

In one aspect of the present invention, the brooding chamber is separated from the free-range chamber by a laterally movable partition.

In another aspect of the present invention, the surrogate system has an improved food source. The food source comprises a floor plate, a stationary vertical plate, and a vertical plate movably positioned with respect to the stationary vertical plate to form an adjustable food opening between the movable vertical plate and floor plate.

In still another aspect of the present invention, the surrogate system has a gravity-fed water container attached to a distribution means for distributing water to said game chicks. In one embodiment, the distribution means comprises a conduit having a plurality of nipples for distributing water to the game chicks.

In yet a further aspect, the exterior of the surrogator system is molded or shaped to retain the water container so that it does not easily tip over.

In another aspect of the present invention, the heat source of the surrogator system is located above the game chicks in the central portion of said brooding chamber. A concave shield is located above the heat source to radiate the heat downwards, and a screen surrounds the heat source to protect the chicks from the heat source.

In another aspect, said brooding chamber and the free-range chamber each have floor screens to permit chick fecal matter to pass therethrough. The floor screens are removable so that a screen having suitably small openings may be used during the early part of the chicks' life when their feet are small.

In still another aspect, the surrogate system (e.g. side walls and top cover) are preferably comprised of plastic. The plastic is theorized to be resistant to condensation accumulation (e.g. compared to metal), have a high specific heat, and also have desirable insulative properties. It is theorized that such material will increase the game chick life and survival because the material will help prevent the chicks from being exposed to high humidity and even drops of dew falling on them.

In one aspect, the surrogate system is comprised of a roto-molded injection-molded, extrusion-molded, blow molded, resin transfer molded, or thermoformed plastic material.

Additional aspects of the invention, together with the advantages and novel features appurtenant thereto, will be set forth in part in the description that follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of the surrogator device of the present invention.

FIG. 2 is a cut-away view of the surrogator device of the present invention in which the top cover of the brooding chamber is raised, and one side wall of the brooding is removed to show the interior of the brooding chamber.

FIG. 3 is a perspective view of the brooding chamber with the top cover raised.

FIG. 4 is a perspective view of the brooding chamber of the surrogator device tipped on its end in which the shield for the heat source has been removed.

FIG. 5 is a cut-away view of the surrogator device of the present invention in which a portion of the side walls of the free-range chamber have been removed to show the interior of the free-range chamber.

FIG. 6 is a side-view illustrating the configuration of the food source of the surrogator device of the present invention.

### DETAILED DESCRIPTION OF PREFERRED EMBODIMENT

As used herein, the term “condensation” refers to the deposit of water vapor from the air on any cold surface whose temperature is below the dew point.

As used herein, the term “quail” refers to several birds in the grouse family that live in North America. The best known of these are bobwhite quail. The protected feeding and watering system of the present invention will be described as it is used in conjunction with this type of quail.

The present invention is directed to an improved surrogator device used to develop a huntable population of quail and other game birds. The quail chicks are placed into the surrogator device at about 1 day to 2 weeks of age, preferably when the chicks are about 1 day to 1 week old. The chicks reside within the surrogator device until about they are about 3 to 7 weeks old, most preferably at about five weeks old. The chicks are then released into the wild. The surrogator device protects the chicks during the time that they are most vulnerable by providing shelter from predators, as well as providing a source of water, food, and heat. In contrast to adult-released birds, the chicks show an increased ability to retain their survival instincts and survive in the wild.

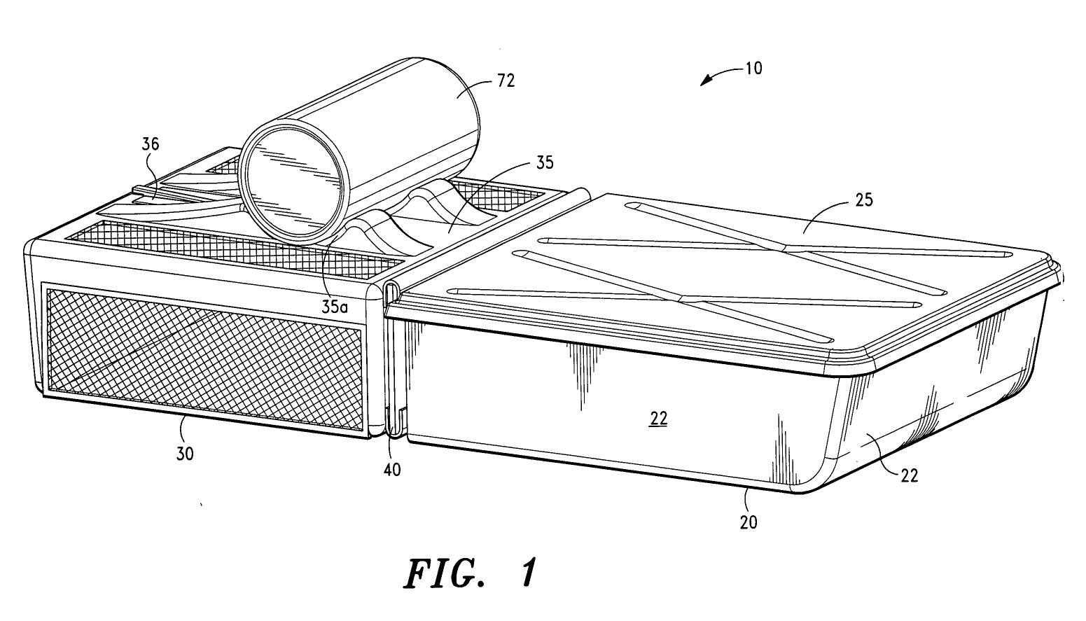

As shown in FIG. 1, the surrogator device 10 has a brooding chamber 20 and a free-range, loafing, or open chamber 30. The surrogator device 10 is constructed of any suitable moisture-proof, non-rusting material. In one aspect, the device is constructed of plastic using conventional methods such as extrusion molding, blow molding, injection molding, resin transfer molding, thermoforming, and rotational molding. In a preferred aspect, the device comprises a roto-molded linear low density polyethylene (“LLDPE”). Exemplary processes of this type are illustrated, for example, in U.S. Pat. Nos. 2,804,654, 3,008,192 and 3,040,376. The plastic is preferably brown and/or green in color to help camouflage the device within the surroundings.

There are several advantages associated with constructing the surrogator device 10 with a plastic material. The use of plastic (compared to conventional metal) significantly reduces the weight of the device, e.g. about a 42% reduction in weight. The plastic device also has desirable insulative properties that provide for more efficient heating of the device. In addition, a plastic device decreases the relative humidity in the brooding chamber 20 by decreasing the amount of condensation, which in turn is believed to decrease chick mortality associated with breathing air with a high humidity.

More specifically, it is theorized the heat source of the surrogator pulls in moisture from the surrounding air. This increases the humidity in the surrogator brooding chamber compared to that of the exterior air. Materials such as metals having high conductivity (low specific heat) have a high heat transfer rates, which results in condensation on the surface,o,f the surrogator chamber walls and cover and exacerbates this humidity problem. The use of insulative material, such as plastic, results a slower heat transfer rate and less condensation on the surfaces of the surrogator chamber. The chick mortality is therefore reduced because the chicks breathe air with decreased humidity and also decreases the risk that drops of condensation will fall on the chicks.

The surrogator device 10 is suitably shaped or sized for the chick population. In one aspect, the surrogator device is rectangular in shape and is sized to hold about 50 to 250 day old quail chicks until they reach about five weeks of age. The typical device is about 8 foot by 4 foot by about 18 inches tall.

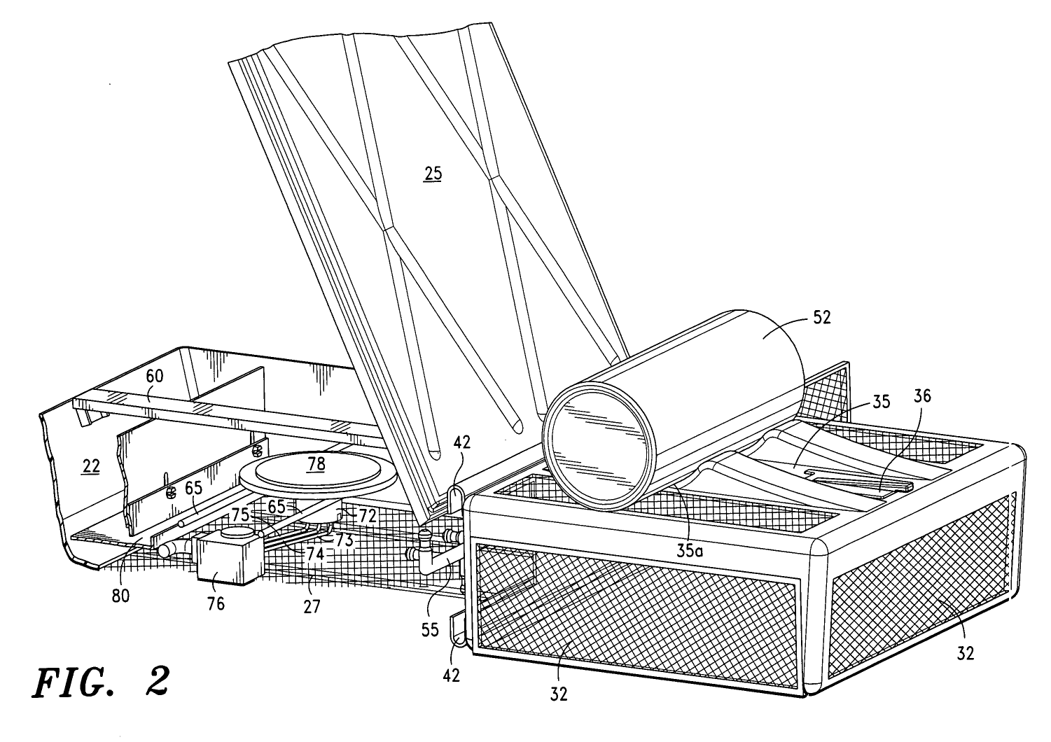

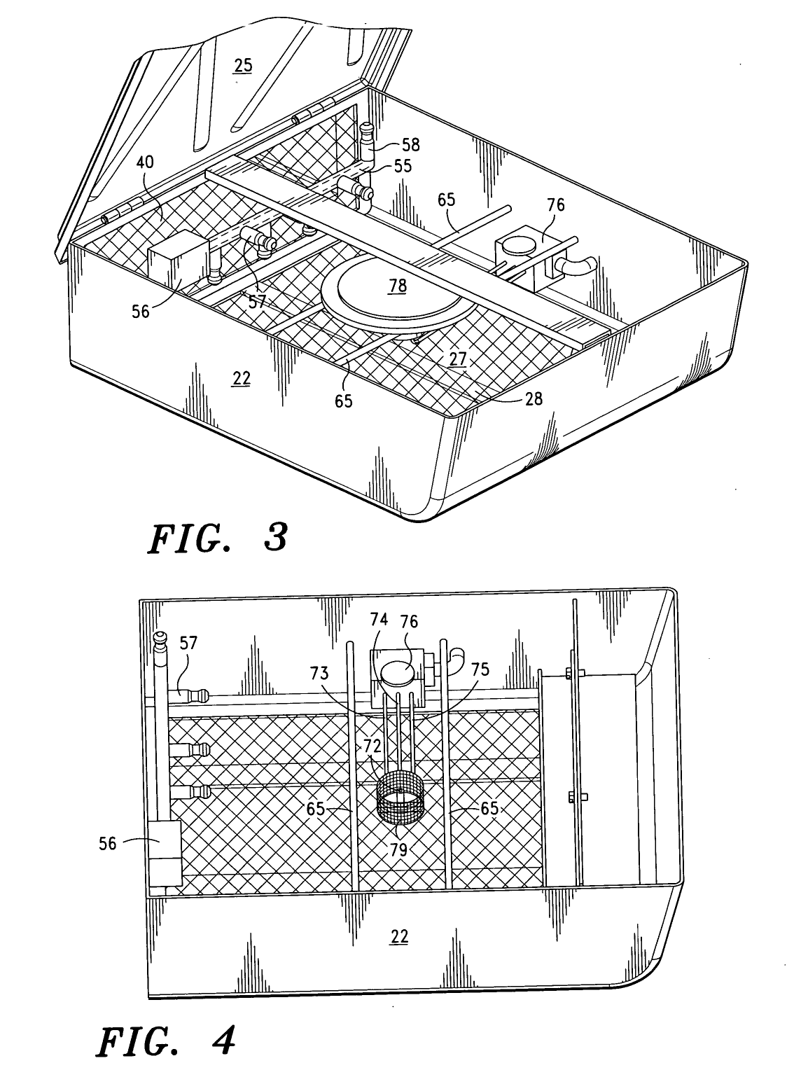

An exemplary brooding chamber 20 is illustrated in FIGS. 2, 3, and 4. The brooding chamber 20 has dimensions of about 4×4 feet. The brooding chamber 20 contains substantially vertical side walls 22 and a top cover 25 which shield the chicks from the sun, wind, rain, and other environmental elements. As discussed above, the side walls 22 and top cover 25 are comprised of a roto-molded plastic material. The top cover 25 is attached to one or more of the side walls 22 using conventional attachment means, such as hinges, screws, velcro, or by molding the lid and the wall in complementary manner, such as a tongue and groove assembly. As shown in FIG. 2, the top cover 25 is pivotally or hingedly attached to the center side wall (which contains a movable partition, as discussed more fully below) using one or more hinges. FIG. 3 illustrates an exemplary hinge in which the barrel of the hinge is formed in the top cover and center side wall and a pin is inserted therethrough. The top cover is also removably engaged with another side wall, e.g. by having a peripheral tongue in the lid engage a groove in the side wall or by providing a peripheral flange that fits down over the side walls. The top cover may optionally have a latch (not shown) so that a predator could not remove the top cover without removing the latch pins.

The brooding chamber 20 contains a floor screen 27 that permits bird fecal matter to pass through the screen and away from the chicks. The screen 27 is attached to the side walls 22 by one or more fasteners (e.g. screws), and one or more metal support bars 28 are added to help provide structural support for the screen. Alternatively, an elevated free-standing screen sized to fit the dimensions of the floor of the brooding chamber is placed within the side walls 22 of the brooding chamber 20.

The floor screen used in the device may vary during the chick surrogator cycle. During the first week of life, the floor screen preferably comprises a rubber or plastic mat having ¼-inch holes. This permits the fecal matter to fall through the matted floor screen. In addition, the holes are sufficiently small so that the small chick feet do not fall through the holes. After the first week, the floor screen 27 is preferably a wire screen having a mesh size of about ½ inch, and is made of a suitable weather-resistant material, such as a coated metal (e.g. galvanized metal) or plastic (e.g. fiberglass, polypropylene, nylon, etc.). In one aspect, the plastic floor is laid over the wire floor then removed at the end of five weeks.

The brooding chamber 20 is separated from the free-range chamber 30 by a movable partition 40, which is discussed more fully below.

The brooding chamber 20 optionally contains one or more cross-bars 60 that extend across opposite side walls 22 for added support and stability. The cross-bars may extend longitudinally (as shown) or transversely (not shown) within the brooding chamber.

The brooding chamber 20 is associated with a water source, heat source, and food source for the chicks. Each of these elements is important to ensure that the chicks have all of the necessities required for survival during the critical first five weeks of life.

The brooding chamber 20 has a water source associated therewith that provides water to the chicks during the first five weeks of life. Preferably, the water source comprises a container 52 having enough water to last about five weeks. The container may be manually refilled as needed. Typically, the water source comprises a 2 to 30 gallon container filled with water that is either gravity-fed or pumped to the chicks. The water container is preferably located above the chicks so that the water is gravity-fed and to help avoid sanitary issues associated with the water source being located on the surrogator floor. The water container 52 is also located on the exterior of the surrogator, preferably above the free-range chamber 30 (as opposed to the brooding chamber 20) so that the water is not undesirably heated by the heat source. In addition, by locating the water container above the free-range chamber, the top cover 25 may be readily moved or opened to provide access to the chicks in the brooding chamber 20.

In one aspect, the water container rests in a “seat” or “saddle” 35a on the top cover 35 of the free-range chamber 30. That is, the top cover of the free-range chamber is molded in a shape to complement the three-dimensional shape of the container 52 so that the container is removably retained thereby. For example, in the case of a barrel-shaped container, a saddle comprising a complementary concave depression is provided in the top cover 35 of the free-range chamber 30.

The water source includes a distribution means for distributing the water to the individual chicks. In one aspect, the distribution means is a trough or other receptacle for holding water. In another aspect, the water is distributed to the chicks using a pipe, hose, or other conduit 55 with a plurality of nipples 57 suitably spaced along the conduit. The nipples are colored (e.g. red, silver) in a manner to attract the young chick's attention. A float 56 may be used to regulate the amount of water provided to the chicks. Water from the container 52 enters the float and exits into the distribution means. The float contains a floatable plug that blocks the opening where the water enters the float. As the chicks drink the water, the water level in the float is lowered so that the floatable plug is correspondingly lowered so that water flows through the opening where the water enters the float. As water travels through the opening and into the float, the water level raises, which cause the floatable plug to again block the opening.

To help ensure that water is available along the entire length of the distribution conduit 55, the distribution conduit is clear or contains measurement means at the distal end relative to the water inlet. As shown in FIG. 8, the measurement means 58 comprises a clear, vertical vent tube such that the water level (i.e. the meniscus) can be seen through the vent tube when water is being adequately distributed through the distribution conduit. Most preferably, the water source is a 15-gallon barrel attached to a conduit having shiny silver and/or red nipples with a clear vertical vent tube at the distal end of the conduit.

The heat source in the brooding chamber 20 provides heat to the chicks, which has been found to significantly decrease the chick mortality rate. Indeed, in most instances, the chicks will die without the heat source. Suitable heating devices include conventional burners (kerosene, propane, wood, and the like), solar or electrical-resistance element types. The heat source is preferably located above the chicks to provide radiant heat in a more uniform manner. In addition, the heat source is preferably centrally located within the brooding chamber by one or more support bars or rods 65 extending from the side walls or top cover (lid) of the brooding chamber. The chicks may move closer to the central portion of the brooding chamber as they get colder.

An exemplary heating source is illustrated in FIGS. 3 and 4. The heating source comprises a burner 72 attached to a gas feed line 73 from an external propane tank (not shown). Next to the burner 72 is a pilot light (not shown), thermocouple 74, and pilot feed line 75, and control valve 76. The pilot light has a pilot shield that surrounds it on three sides to help prevent the pilot light from being extinguished from the wind or any chick movement. An overlying shield 78 is also positioned around the heat source to help protect the heat source from wind, to prevent the top cover 25 of the brooding chamber 20 from catching fire or melting, and to help distribute the radiant heat. The shield 78 is preferably comprised of a non-flammable insulating material, such as a ceramic material. The shield 78 is also preferably concave or generally conical in shape to help radiate the heat downward toward the chicks. In addition, a peripheral wire mesh screen 79 surrounds the burner 72 to help protect the chicks from injuring themselves by coming too close to the heat source.

The temperature of the device is controlled by the thermostat. The thermostat is manually adjusted between 70 and 90 degrees ° F., or is automatically controlled using a programmable thermostat. The temperature inside the brooding chamber is preferably warmer during the first part of the surrogator cycle and then is reduced. For example, during the first week, the temperature is preferably at about 90° F., the second week the temperature is maintained at about 80° F., and the third week, the temperature is maintained at about 70° F. The temperatures are preferably measured underneath and in close proximity to the heat shield.

The food source contains food for the chicks, which includes chick crumbs, dry egg food, small seeds, and even insects' parts. The food source is preferably a trough or tray 80 that is permanently or removably attached to the side wall of the brooding chamber 12. The tray is sized to hold about 10 to 100 pounds, most preferably about 40 to 60 pounds of chick food when full. If necessary, the top cover 25 of the brooding chamber 20 may be removed to gain access to the trough so that it may be refilled. The food source is positioned close to the bottom of the surrogator so that the chicks may readily obtain the food contained therein.

An exemplary food trough 80 is illustrated in FIGS. 2, 4, and 6. The food trough 80 comprises a floor plate 82, a stationary vertical plate 84, and a movable vertical plate 86. Food is placed between the side wall 22 and the stationary vertical plate 84 and rests on the floor plate 82. The movable vertical plate 86 is movably positioned (by a slot and pin mechanism) against the stationary vertical plate 84 to create an adjustable food opening 88. The food is metered through the adjustable food opening 88 to ensure that the appropriate amount is available for the chicks. The floor plate 82 preferably contains a flange 83 to help retain the food on the floor plate 82 after being metered through the adjustable food opening 88 and does not fall to the ground. Typically, the floor plate 82 is about 1 to 2 inches from the floor screen 27 of the surrogator.

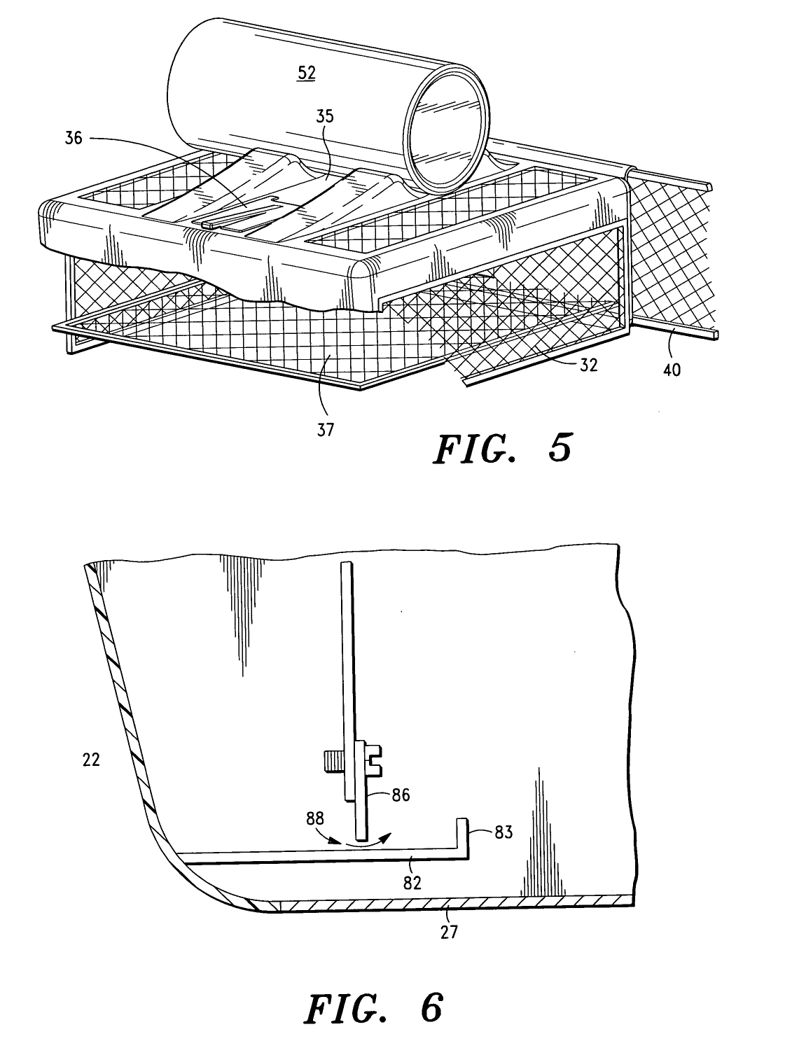

The free-range chamber 30 has dimensions of about 4×4 feet. As shown in FIGS. 1, 2, and 5, the free-range chamber also contains substantially vertical side walls 32 and a top cover 35. In contrast to solid walls 22 of the brooding chamber 20, the side walls 32 of the free-range chamber 30 contain various small openings, such as those associated with cage bars, grates, and screens, which assists the chicks in becoming acclimated to their surroundings. Typically, each of the side walls 32 is comprised of a ¼ to ⅝ inch hexagonal wire or plastic mesh. The top cover 35 is preferably at least partially open (e.g. screened). The free-range chamber permits the chicks to be exposed to the moisture, sun, wind, rain, and other environmental conditions, helping the chicks to adapt to life in the wild.

The top cover 35 of the free-range chamber 30 also includes a large opening for removal of any chicks that have perished from the free-range chamber. The opening is covered by a gate or door 36 that is hinged on one end. The gate 36 is removably secured to the top cover using a latch or hook

The free-range chamber 30 also contains a floor screen 37 similar to the screen 27 of the brooding chamber 20 designed to permit bird fecal matter to pass through the screen and away from the chicks. The screen 37 is attached to the vertical walls 32 by one or more fasteners, and one or more support bars 38 are optionally added to help provide structural support for the screen. Alternatively, an elevated free-standing screen sized to fit the dimensions of the free-range chamber of the surrogator device may be used.

A movable partition separates 40 the brooding chamber 20 from the free-range chamber 30. The partition 40 is a metal or plastic screen (e.g. a perforated metal with an ⅛-inch opening throughout) which is removed from the device through a partition opening 42 adjacent the brooding chamber side wall 22 and free-range chamber side wall 32. The partition moves laterally (side-to side) through the partition opening 42.

In use, the chicks are introduced into the brooding chamber 20 shortly after birth, preferably on about day 1 or day 2. The partition 40 is moved to close off the brooding chamber 20 from the free-range chamber 30 such that the chicks remain in the brooding chamber for about the first week after being born. As such, the chicks become familiarized as to the source of food, water, and heat. The chicks are also not exposed to the elements in the free-range chamber 30 during this fragile period of life. When the chicks are about one week of age, the partition 40 is removed so that the chicks may freely move within the entire surrogate device enclosure and imprint to their surroundings.

The partition 40 is also useful for maintenance of the surrogator device 10. For example, when the chicks are about three weeks old, the heating source is preferably removed. During this maintenance, all of the chicks are moved to the free-range chamber and retained therein by the partition 40. The heat source is removed to help keep the birds from injuring themselves on the heating unit hardware as they grow, to prevent them from attempting to eat the ceramic shield 78, and to provide more room to move in the device itself.

Although the surrogator device of the present invention has been described in conjuction with quail chicks generally, it will be appreciated that the surrogator device may be sized to fit other wild game birds. Further, multiple surrogator devices may be used at the same time in order to increase the number of quail chicks being raised. In addition, the five-week cycle may be repeated multiple times during a season.

The terms “front”, “rear”, “side”, “top”, “bottom” and so forth have been herein merely for convenience to describe the present invention and its parts as oriented in the drawings. It is to be understood, however, that these terms are in no way limiting to the invention.

From the foregoing it will be seen that this invention is one well adapted to attain all ends and objectives herein-above set forth, together with the other advantages which are obvious and which are inherent to the invention. Further, since many possible embodiments may be made of the invention without departing from the scope thereof, it is to be understood that all matters herein set forth or shown in the accompanying drawings are to be interpreted as illustrative, and not in a limiting sense.

What is claimed and desired to be secured by Letters Patent is as follows:

1. A surrogate system for game chicks up to about five weeks of age comprising:
a brooding chamber having an interior and an exterior, said brooding chamber shielding the game chicks from the wind and rain and having a food source, a water source, and a heat source for said game chicks; and
a free-range chamber having an interior and an exterior, said free-range chamber permitting the chicks to be exposed to the wind and rain; and
and a laterally movable partition separating said brooding chamber from said free-range chamber.

2. The system of claim 1 wherein said food source comprises a floor plate, a stationary vertical plate, and a vertical plate movably positioned with respect to said stationary vertical plate to form a food adjustable food opening between said movable vertical plate and said floor plate.

3. The system of claim 1 wherein water source comprises a gravity-fed container having water therein, said chamber attached to a distribution means for distributing water to said game chicks.

4. The system of claim 3 wherein said distribution means comprises a conduit having a plurality of nipples for distributing water to said game chicks.

5. The system of claim 4 wherein further comprising a measurement means, said measurement means attached to said distribution means, said measurement means comprising a tube such that the meniscus of water in the tube can be seen through the tube when water is being adequately distributed through the distribution means.

6. The system of claim 1 wherein said water source comprises a water container having a three-dimensional shape that is removably retained on a cover of said free-range chamber by shaping said cover to complement the three-dimensional shape of said water container.

7. The system of claim 1 wherein said heat source is located above said game chicks in a central portion of said brooding chamber.

8. The system of claim 1 wherein a shield is located above said heat source, and wherein a screen surrounds said heat source to protect the chicks from the heat source.

9. The system of claim 8 wherein said shield is concave in shape to help radiate heat from the heat source downward toward said chicks.

10. The system of claim 1 wherein said brooding chamber has a floor screen, said brooding chamber floor screen raised to permit chick fecal matter to pass therethrough.

11. The system of claim 1 wherein said free-range chamber has a floor screen, said free-range chamber floor screen raised to permit chick fecal matter to pass therethrough.

12. The system of claim 1 wherein said brooding chamber comprises a plurality of side walls and a cover, said side walls and cover comprised of plastic.

13. The system of claim 1 wherein said free-range chamber comprises a plurality of side walls and a cover, said side walls and cover comprised of metal or plastic screens.

14. The system of claim 1 wherein said partition comprises a movable screen that may be removed through an opening between said brooding chamber and said free-range chamber.

15. The system of claim 14 wherein said movable screen moves through an opening between a sidewall of said brooding chamber and a side wall of said free-range chamber.

16. A method for increasing game chick life comprising:
providing a surrogator device comprising of a brooding chamber and a free-range chamber,
said brooding chamber having an interior and an exterior, said brooding chamber having a food source, a water source, and a heat source, and said brooding chamber comprising a plastic material;
said free-range chamber having an interior and an exterior;
providing a movable partition separating said brooding chamber from said free-range chamber;
introducing one or more game chicks into said surrogator device when said game chicks are between about 1 day and about 2 weeks of age;
removing said game chicks from the surrogator device and releasing said game chicks into the wild between about 3 and 7 weeks of age.

17. The method of claim 16, wherein said plastic material for increasing game chick.-life comprises a roto-molded injection-molded, extrusion-molded, blow molded, resin transfer molded, or thermoformed plastic material.

18. The method of claim 16 further comprising the step of removing said partition separating said brooding chamber from said free-range chamber about 1 to 2 weeks after said chicks are introduced into said chamber, said removing step permitting said chicks to freely transgress between said free-range chamber and said brooding chamber.

19. The method of claim 16 wherein said game chicks are released into the wild at about five weeks of age.

20. The method of claim 16 wherein said heat source maintains the brooding chamber at a first temperature and then maintains the brooding chamber at a second temperature, said second temperature being lower than said first temperature.

21. The method of claim 20 wherein said heat source maintains the brooding chamber at a first temperature of about 90° F. for about one week and then maintains the brooding chamber at a second temperature of about 80° F. for about one week.

22. The method of claim 21 wherein said heat source maintains the brooding chamber at a third temperature, said third temperature being lower than said second temperature.
